(19) United States
(12) Patent Application Publication
(10) Pub. No.: US 2020/0262236 A1
(43) Pub. Date: Aug. 20, 2020

(54) SPOKE AND NON-PNEUMATIC WHEEL

(71) Applicant: COMPAGNIE GENERALE DES ETABLISSEMENTS MICHELIN, CLERMONT-FERRAND (FR)

(72) Inventors: Antonio DELFINO, Givisiez (CH); Agnes PAULBOT, Clermont-Ferrand (FR); Nicolas JAUNET, Chaleaugay (FR)

(21) Appl. No.: 16/645,198

(22) PCT Filed: Sep. 8, 2017
(86) PCT No.: PCT/IB2017/055435

§ 371 Date: Mar. 6, 2020

(51) Int. Cl. B60B 9/26

(52) U.S. Cl. CPC B60B 9/26; B60B 2360/102; B60B 2360/341

(57) ABSTRACT

A spoke for a non-pneumatic wheel and the wheel incorporating such spoke. The spoke is provided with one or more features that, may allow e.g., a non-pneumatic tire of the wheel to be removed from a wheel hub so that another hub or tire can be substituted. The spoke has a reinforcement structure that may include one or more features providing support for operation of the non-pneumatic wheel.

### FIELD OF THE INVENTION

The subject matter of the present disclosure relates generally to a spoke for a non-pneumatic wheel and a wheel incorporating such spoke.

### BACKGROUND OF THE INVENTION

The pneumatic tire is a known solution for compliance, comfort, mass, and rolling resistance. However, the pneumatic tire has disadvantages in complexity, the need for maintenance, and susceptibility to damage. A device that improves on pneumatic tire performance could, for example, provide more compliance, better control of stiffness, lower maintenance requirements, and resistance to damage.

Non-pneumatic tire or wheel constructions provide certain such improvements. The details and benefits of non-pneumatic tire or non-pneumatic wheel constructions are described in e.g., U.S. Pat. Nos. 6,769,465; 6,994,134; 7,013,939; and 7,201,194. Certain non-pneumatic tire and wheel constructions propose incorporating a resilient, annular shear band, embodiments of which are described in e.g., U.S. Pat. Nos. 6,769,465 and 7,201,194. Such non-pneumatic tire and wheel constructions provide advantages in performance without relying upon a gas inflation pressure for support of the loads applied to the tire or wheel.

In some non-pneumatic constructions, vehicle load is applied to a wheel hub that is connected with an annular shear band through load bearing members in the form of e.g., a web or spoke. These members can transmit the load to the annular shear band through e.g., tension, compression, or both. A layer of tread can be applied to the shear band to provide protection against from the travel surface.

The non-pneumatic wheel may wear or suffer damage during use. For example, the tread may wear, the load bearing members may be cut or nicked, and other effects from usage may occur. For certain constructions, the tread, load bearing members, and annular band may be constructed from various polymeric materials that wear or age from use while the hub may be constructed from one or more metals and could potentially be reused.

However, replacement or repair of the tread or the load bearing members may not be practical or economical. For example, because of the integral construction of the hub and load bearing members, prior non-pneumatic wheels may not be readily amenable to substituting different spokes or an annular band into the non-pneumatic wheel, substituting different hubs into the non-pneumatic wheel, or both. Such a substitution would require e.g., destructive steps to cut or extricate the spoke from the annular band or the hub of the non-pneumatic wheel.

Accordingly, a spoke for a non-pneumatic wheel that can be more readily molded with reinforcements, various shapes, one or more layers of material, and other features would be useful. Such a spoke that can be readily incorporated into a non-pneumatic wheel without integral construction with the wheel hub would also be beneficial. A spoke that can be more readily connected and disconnected from the wheel hub, the compliant band, or both, would also be useful. A non-pneumatic wheel incorporating such spoke would also be beneficial.

### SUMMARY OF THE INVENTION

The present invention provides a spoke for a non-pneumatic wheel and the wheel incorporating such spoke. The spoke is provided with one or more features that may allow e.g., a non-pneumatic tire of the wheel to be removed from a wheel hub so that another hub or tire can be substituted. The spoke has a reinforcement structure that may include one or more features providing support for operation of the non-pneumatic wheel. Additional objects and advantages of the invention will be set forth in part in the following description, or may be apparent from the description, or may be learned through practice of the invention.

In one exemplary embodiment, the present invention provides a spoke for a non-pneumatic wheel defining radial, axial, and circumferential directions. The spoke includes a web-like body extending along the radial direction between a radially-outer end and a radially inner end and extending along an axial direction between opposing edges of the web-like body. The web like body includes a reinforcement structure extending along the radial direction. An outer anchor is positioned at the radially outer end and includes an outer pair of arms extending in an opposing manner along the circumferential direction away from the web-like body. An inner anchor is positioned at the radially inner end and includes an inner pair of arms extending in an opposing manner along the circumferential direction away from the web-like body.

In certain embodiments, the reinforcement structure may include an outer fold at the radially-outer end and an inner terminus at the radially-inner end. In certain embodiments, the reinforcement structure may include an outer terminus at the radially-outer end and an inner fold at the radially-inner end. In still other embodiments, the reinforcement structure includes an inner terminus at the radially-inner end and an outer terminus at the radially-outer end.

The present invention also includes non-pneumatic wheels incorporating the spokes of these embodiments.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 illustrates a side view of exemplary non-pneumatic wheel of the present invention.

FIG. 2 is a cross-sectional view of a portion of the exemplary wheel of FIG. 1 taken along line 2-2 in in FIG. 1.

FIG. 3 is a perspective view of an exemplary spoke of the present invention.

FIG. 4 is a cross-sectional end view of an exemplary spoke of the present invention.

FIG. 5 is a cross-sectional end view of a portion of the exemplary spoke of FIG. 4.

FIG. 6 is a perspective view of another exemplary spoke of the present invention.

FIG. 7 is a cross-sectional end view of another exemplary spoke of the present invention.

FIG. 8 is a cross-sectional end view of another exemplary spoke of the present invention.

### DETAILED DESCRIPTION

For purposes of describing the invention, reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment, can be used with another embodiment to yield a still further embodiment. Thus, it is intended that the present invention covers such modifications and variations as come within the scope of the appended claims and their equivalents

As used herein, the following definitions apply.

Axial direction A refers to a direction parallel to an axis about which a referenced exemplary wheel or tire rotates during use.

Radial direction R refers to a direction perpendicular to axial direction A with radially-outer or radially outward referring to a general direction away from axial direction A, and radially-inner or radially inward referring to a general direction towards axial direction A.

Circumferential direction C refers to a direction defined by the circumference of the wheel or tire, or the direction of rotation the wheel or tire about an axis.

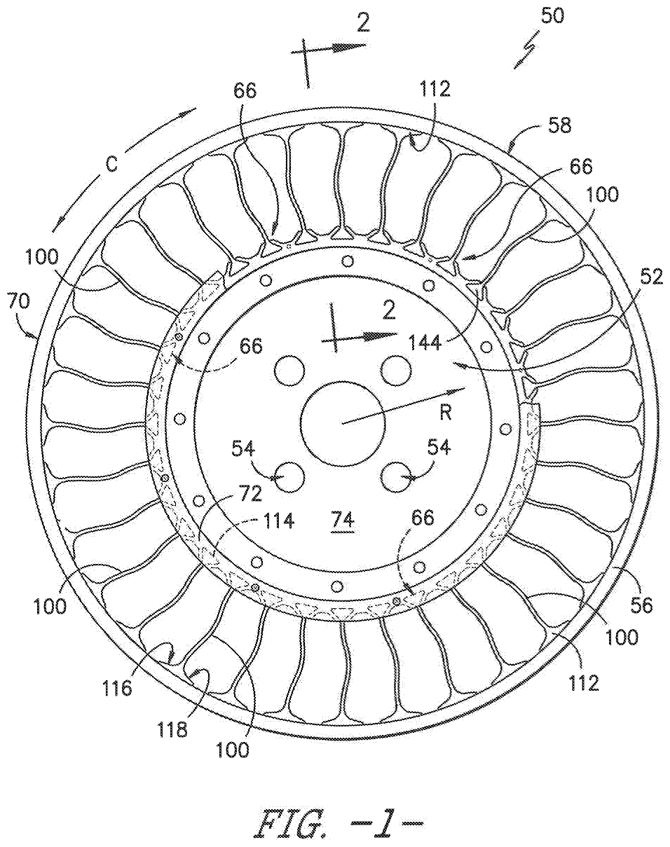

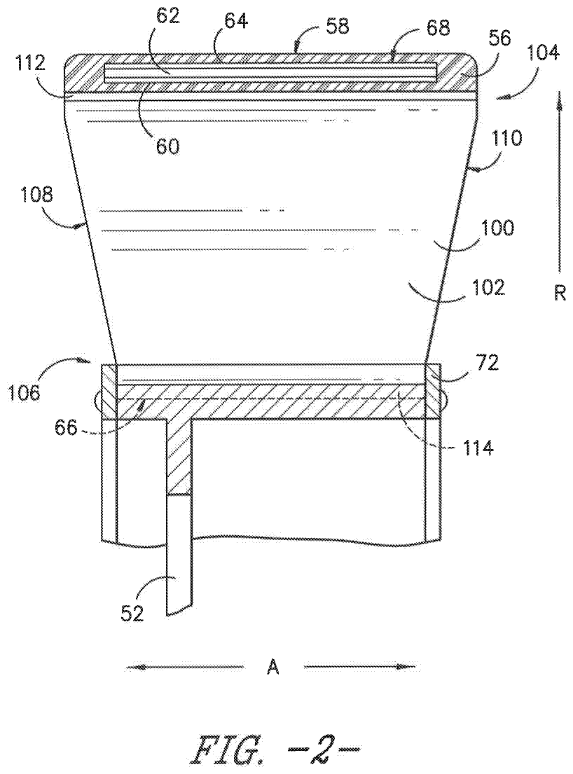

FIG. 1 provides a side view of an exemplary non-pneumatic wheel 50 of the present invention while FIG. 2 provides a cross-sectional view of wheel 50 taken along a meridian plane at line 2-2 in FIG. 1. The present invention is not limited to the particular shape, size, or appearance of the wheels shown in any of the figures. As will be understood using the teachings disclosed herein, wheels of other shapes, sizes, and appearances may be used as well.

Wheel 50 includes a non-pneumatic tire 70 supported on wheel hub 52, which includes an annular receiver 72 and a central portion 74. Central portion 74 is provided with a series of apertures 54 through which threaded lugs or other fasteners may be inserted in order to mount wheel 50 onto e.g., the axle of a vehicle. Central portion 74 may be e.g., welded to annular receiver 72, fastened to annular receiver 72, or formed integrally therewith. The appearance and features of hub 52, and particularly central portion 74, are provided by way of example only and other configurations may be used as well.

Non-pneumatic wheel 50 also includes a compliant, load supporting band 56 positioned radially outward of a hub 52 and positioned concentrically with hub 52. A plurality of load supporting members or spokes 100 extend along the radial direction R between hub 52 and load supporting band 56. A tread 58 may be formed on, or provided as part of, load supporting band 56. For example, tread band 58 may be adhered to load supporting band 56, embedded therein, or formed integrally as shown in FIG. 2. Other constructions may be used as well. Band 56 includes a shear band 68 that provides a stiffness that allows spokes 100 to support hub 52 during use of wheel 50 on a vehicle. At the same time, hand 56 provides a resiliency or compliance over the ground surface that provides for a smoother, more comfortable ride.

By way of example, load supporting band 56 may be constructed to include shear band 68 having an inner reinforcing band 60, outer reinforcing band 64, and a shear layer 62 positioned therebetween. Shear layer 62 may be constructed e.g. of an elastomeric material such as e.g., natural and synthetic rubbers, polyurethanes, foamed rubbers and polyurethanes, segmented copolyesters, and block co-polymers of nylon. The reinforcing bands 60, 64 may include reinforcements constructed from e.g., essentially inextensible cord reinforcements embedded in an elastomeric coating. Such reinforcements may include e.g., any of several materials suitable for use as tire belt reinforcements in conventional tires such as cords of steel, composites of glass and resin such as e.g., fiberglass reinforced plastics, and other materials having a high modulus in tension and compression. Other constructions including e.g., different layers and materials may be used as well.

Spokes 100 are adjacent to one another and spaced apart about circumferential direction C of wheel 50. Spokes 100 may have other shapes and configurations from what is shown in FIGS. 1 and 2. For example, although shown as somewhat linear in the figures, spokes 100 may also have a curved shape. In one exemplary embodiment, each spoke 100 is provided with substantially the same curvature along radial direction R (as viewed along axial direction A) so that e.g., spokes 100 may buckle in the same way as they pass through the contact patch. By way of further example, edges 108 and 110 may also be provided with non-linear shapes to provide a profile different from what is shown in FIG. 2. Spokes 100 may also be formed at various angles from radial direction R. Using shear band 68, load supporting band 56 supports loads transmitted to non-pneumatic wheel 50 when mounted to a vehicle using central portion 74. The load is transmitted through spokes 100 to compliant band 56 by tension, compression, or both. In one exemplary embodiment, as wheel 50 rotates, spokes 100 may be in tension as they reach the top of the wheel at a position away from the contact patch while spokes 100 near the contact patch may experience minimal tension, may support load in compression, and may even slightly buckle or bend.

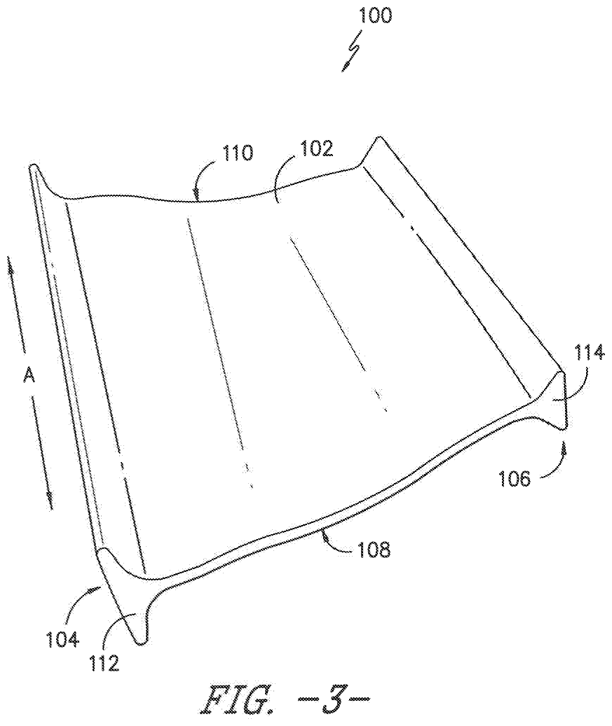

FIGS. 2 and 3 provide views of exemplary embodiments of spoke 100. As shown, spoke 100 includes a web-like body 102 extending along the radial direction R. Arrow R points along a radial direction from radially-inward to radially-outward as used in reference to the position and orientation of spoke 100 or its components within non-pneumatic wheel 50 (FIG. 1). Along radial direction R, web-like body 102 extends between a radially outer end 104 and a radially-inner end 106. Along axial direction A, web-like body 102 extends between opposing edges 108 and 110.

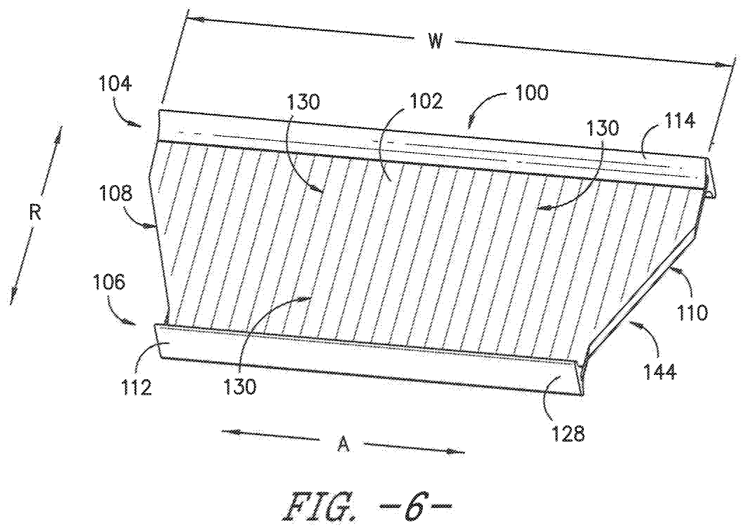

A variety of shapes may be used for web-like body 102. For example, as shown in FIGS. 2 and 3, web-like body 102 has a width W that increases along radial direction R moving from the radially-inner end 106 to radially-outer end 104. In other embodiments, width W may decrease, remain constant, or vary. Additionally, the thickness T of web-like body 102 along circumferential direction C may be uniform as shown in Fla 3 or may vary along radial direction R. FIG. 6, for example, illustrates another exemplary embodiment of spoke 100 having a different shape for web-like body 102.

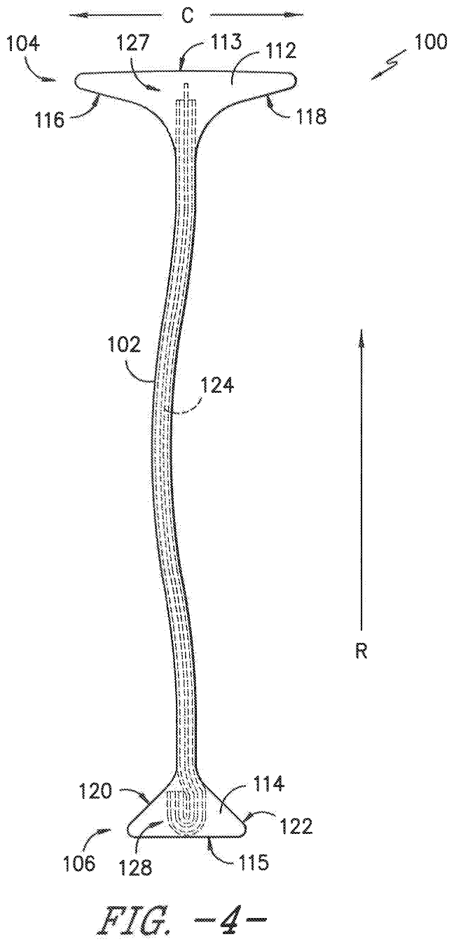

Referring to FIGS. 3 and 4, the radially outer end 104 of web-like body 102 forms an outer anchor 112 while the radially-inner end 106 forms inner anchor 114. Anchor 112 includes a radially-outer anchor surface 11.3 while anchor 114 includes a radially ironer surface 115. For this exemplary embodiment, outer anchor 112 includes an outer pair of arms 116 and 118 that extend in an opposing manner or away from each other and body 102 along circumferential direction C. Similarly, inner anchor 114 includes an inner pair of arms 120 and 122 that extend in opposing manner or away from each other and body 102 along circumferential direction C. The present invention is not limited to the particular shape for web spoke 100 shown in the figures and other shapes and configurations may also be used. For example, while web spoke 100 has a familiar “I” shape as shown in FIG. 3 with triangular portions for anchors 112 and 114, other shapes can be used as well.

Anchors 112 and 114 provide versatility to the use of spoke 100 and its integration into wheel 50. For example, as shown in FIGS. 1 and 2, inner anchor 114 is removably installed within an axially-oriented slot or channel 66 of hub 52. During manufacture, inner anchor 114 can be readily slid along axial direction A or otherwise inserted into channel 66. Such construction also allows hub 52 to be readily substituted in the event of e.g., a desired change, repair, or otherwise of hub 52. Conversely, such construction also allows for substitution of a different non-pneumatic tire 74 onto hub 52 in the event of e.g., wear of tread 58, damage to one or more spokes 100, or other event for which a change-out of tire 74 is desirable.

For this exemplary embodiment, outer anchor 112 is attached to annular band 56. A variety of methods may be used to attach band 56 and outer anchor 112. For example, outer anchor 112 may be mechanically fastened or adhered to band 56. Alternatively, outer anchor 112 could be integrally formed with band 56. Other constructions may also be used.

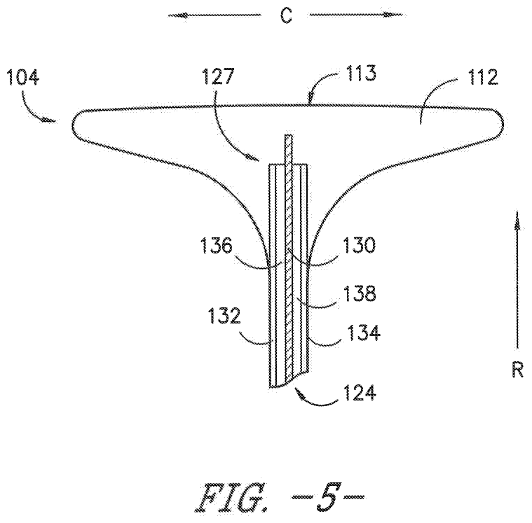

Referring to the exemplary embodiment of FIGS. 4 and 5, web-like body 102 includes a reinforcement structure 124. As shown, reinforcement structure 124 extends along radial direction R between radially-outer end 104 and radially-inner end 106. For this exemplary embodiment, reinforcement structure 124 is provided with an inner fold 128 at radially-inner end 106. Fold 128 provides strength to spoke 100 while also helping secure the end of reinforcement structure 124 in anchor 114. For example, fold 128 assists reinforcement structure 124 in transmitting forces between hub 52 and compliant band 56. Fold 128 is positioned between arms 120 and 122 along circumferential direction C.

At radially-outer end 104, reinforcement structure 124 is unfolded or lacks any fold. Instead, in this embodiment, radially-outer end 104 includes a radially-outer terminus 127 that projects from web-like body 102 directly into outer anchor 112 towards radially-outer surface 113 and is centrally located between arms 116 and 118 along circumferential direction C. As such, reinforcement structure 124 lacks a fold in outer anchor 112 because, for certain applications such fold is unnecessary.

For this exemplary embodiment, as depicted in FIGS. 4, 5, and 6, reinforcement structure 124 includes a plurality of elongate, reinforcement elements 130. In one exemplary embodiment, reinforcement elements 130 are provided as inextensible cords 130 extending adjacent and parallel to each other along radial direction R. More particularly, for this embodiment, reinforcement elements 130 have a length that extends along radial direction R—i.e. reinforcement elements 130 extend longitudinally along radial direction R. Other orientations may be used.

For one exemplary embodiment, as used herein, “inextensible” means the material has an elongation at break of 12 percent or less as measured at 23° C. according to ASTM 885. By way of example, cords 130 may be constructed from nylon, steel, combinations thereof, and other materials as well. Cords 130 may be positioned across the entire axial width W of web-like body 102 so that cords 130 are near edges 108 and 110 (FIG. 6) or, alternatively, may be positioned across only a portion of width W such that cords 130 are spaced apart from edges 108 and 110.

Referring to FIGS. 4 and 5, reinforcement structure 124 can include a plurality of layers of polymeric material to form web-like body 102 as well. For example, in one exemplary embodiment, reinforcement structure 124 includes at least one pair of layers of polymeric material 136 and 138 with inextensible cords 130 embedded or sandwiched between layers 136 and 138. Layers 136 and 138 extend between the radially-outer end 104 and radially-inner end 106 and, therefore, have substantially the same length and shape as reinforcement structures 124.

For this exemplary embodiment, layers 136 and 138 form a first pair of layers immediately adjacent to cords 130 and a second pair of layers 132 and 134 are positioned outside of first pair of layers 136, 138. As with layers 136 and 138, layers 132 and 134 extend between the radially-outer end 104 and radially inner end 106 and, therefore, have substantially the same length and shape as reinforcement structures 124. Layers 132, 134, 136, and 138 may be folded at radially-inner end 106 as shown in FIG. 4.

Various materials can be used for layers 132, 134, 136, and 138. In one exemplary embodiment of the invention, first pair of layers 136, 138 are constructed from a first polymeric material while second pair of layers 132, 134 are constructed from a second polymeric material. For example, the first polymeric material may have e.g., an elongation modulus MA10 (according to ASTM D412) measured at 10 percent elongation and at a temperature of 23° C. that is in the range of 1 to 10 MPa (megapascals). The second polymeric material may have e.g., an elongation modulus MA10 (according to ASTM D412) measured at 10 percent elongation and at a temperature of 23° C. that is in the range of 1 to 5 MPa. The first and second polymeric materials may be constructed of elastomeric materials that are tacky such that e.g., they will self-adhere or stick to themselves and/or each other during manufacture.

Various materials may be used for outer anchor 112 and inner anchor 114. For example, outer anchor 112 may be constructed from a polymeric material having e.g., an elongation modulus MA10 (according to ASTM D412) measured at 10 percent elongation and at a temperature of 23° C. that is in the range of 10 to 30 MPa (megapascals). Inner anchor 114 may be constructed from a polymeric material having e.g., an elongation modulus MA10 (according to ASTM D412) measured at 10 percent elongation and at a temperature of 23° C. that is in the range of 20 to 60 MPa (megapascals).

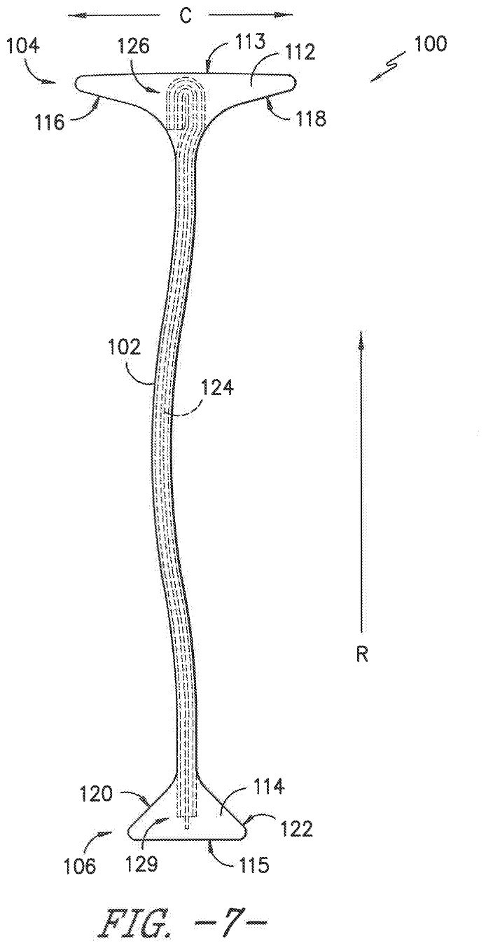

FIG. 7 illustrates another exemplary embodiment of a spoke 100 of the present invention similar to that of FIGS. 3, 4 and 5 except lacking fold 128. More particularly, for this embodiment reinforcement structure 124 is provided with an outer fold 126 at radially-outer end 104. Fold 126 provides strength to spoke 100 while also helping secure the end of reinforcement structure 124 in anchor 112. For example, fold 126 assists reinforcement structure 124 in transmitting forces between hub 52 and compliant band 56.

At radially-inner end 106, reinforcement structure 124 is unfolded or lacks any fold. Instead, in this embodiment, radially-inner end 106 includes a radially-inner terminus 129 that projects radially-inward from web-like body 102 directly into inner anchor 114 towards radially-inner surface 115 and is centrally located between arms 120 and 122 along circumferential direction C. As such, reinforcement structure 124 lacks a fold in inner anchor 114 because, for certain applications, such fold is unnecessary. Reinforcement structure 124 and spoke 100 may otherwise be constructed as previously described for the exemplary embodiments of FIGS. 3, 4, and 5.

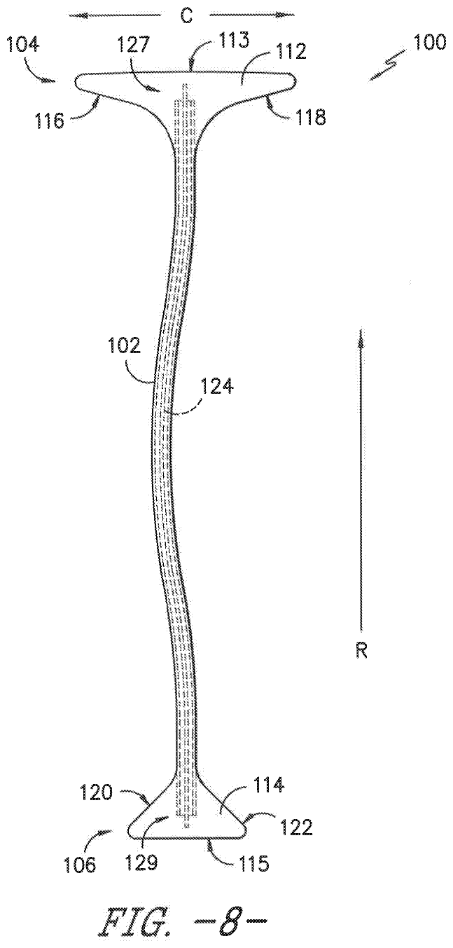

FIG. 8 illustrates still another exemplary embodiment of a spoke 100 of the present invention similar to previous embodiments except lacking fold 126 or 128. As with the embodiment of FIGS. 4 and 5, at radially-outer end 104, reinforcement structure 124 is unfolded or lacks any fold. Instead, radially-outer end 104 includes a radially-outer terminus 127 that projects from web-like body 102 directly into outer anchor 112 towards radially-outer surface 113 and is centrally located between arms 116 and 118 along circumferential direction C. Similar to the embodiment of FIG. 7, at radially-inner end 106, reinforcement structure 124 is unfolded or lacks any fold. Instead, radially-inner end 106 includes a radially-inner terminus 129 that projects radially-inward from web-like body 102 directly into inner anchor 114 towards radially-inner surface 115 and is centrally located between arms 120 and 122 along circumferential direction C. As such, reinforcement structure 124 lacks a fold in outer anchor 112 or inner anchor 114 because, for certain applications, such fold is unnecessary. Reinforcement structure 124 and spoke 100 may otherwise be constructed as previously described for the exemplary embodiments of FIGS. 3, 4, and 5.

While the present subject matter has been described in detail with respect to specific exemplary embodiments and methods thereof, it will be appreciated that those skilled in the art, upon attaining an understanding of the foregoing may readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art using the teachings disclosed herein.

1. A spoke for a non-pneumatic wheel defining radial, axial, and circumferential directions, the spoke comprising:
a web-like body extending along the radial direction between a radially-outer end and a radially inner end and extending along an axial direction between opposing edges of the web-like body, the web like body comprising a reinforcement structure extending along the radial direction, wherein the reinforcement structure comprises an inner terminus at the radially-inner end, an outer terminus at the radially-outer end and an inner fold at the radially-inner end, or an inner terminus at the radially-inner end and an outer terminus at the radially-outer end;
an outer anchor positioned at the radially outer end and comprising an outer pair of arms extending in an opposing manner along the circumferential direction away from the web-like body; and
an inner anchor positioned at the radially inner end and comprising an inner pair of arms extending in an opposing manner along the circumferential direction away from the web-like body.

2. The spoke for a non-pneumatic wheel as in claim 1, wherein the reinforcement structure comprises an outer fold at the radially-outer end and an inner terminus at the radially-inner end.

3. The spoke for a non-pneumatic wheel as in claim 1, wherein the reinforcement structure comprises an outer terminus at the radially-outer end and an inner fold at the radially-inner end.

4. The spoke for a non-pneumatic wheel as in claim 1, wherein the reinforcement structure comprises an inner terminus at the radially-inner end and an outer terminus at the radially-outer end.

5. The spoke for a non-pneumatic wheel as in claim 1, wherein the reinforcement structure comprises a plurality of inextensible cords extending between the radially-outer end and the radially-inner end.

6. The spoke for a non-pneumatic wheel as in claim 1 through wherein the reinforcement structure comprises:
a plurality of inextensible cords extending between the radially-outer end and the radially-inner end; and
at least one pair of layers comprising a polymeric material, wherein the layers extend between the radially-outer end and the radially inner end with the inextensible cords embedded between the layers.

7. The spoke for a non-pneumatic wheel as in claim 6, wherein the inextensible cords comprise steel.

8. The spoke for a non-pneumatic wheel as in claim 6, wherein the inextensible cords comprise fiber reinforced plastics.

9. The spoke for a non-pneumatic wheel as in claim 1, wherein the reinforcement structure comprises:
a plurality of inextensible cords extending between the radially-outer end and the radially-inner end; and
a first pair of layers comprising a first polymeric material, wherein the first pair of layers extend between the radially-outer end and the radially-inner end with the inextensible cords embedded between the first pair layers; and
a second pair of layers comprising a second polymeric material, wherein the second pair of layers extend between the radially-outer end and the radially-inner end.

10. The spoke for a non-pneumatic wheel as in claim 9, wherein the first polymeric material has an elongation modulus MA10 measured at 10 percent elongation and at a temperature of 23° C. that is in the range of 1 to 10 MPa.

11. The spoke for a non-pneumatic wheel as in claim 10, wherein the second polymeric material has an elongation modulus MA10 measured at 10 percent elongation and at a temperature of 23° C. that is in the range of 1 to 5 MPa.

12. The spoke for a non-pneumatic wheel as in claims 1 through 4, wherein the reinforcement structure comprises a plurality of inextensible cords extending between the radially-outer end and the radially-inner end, and wherein the inextensible cords are positioned in a parallel and adjacent manner along the axial direction and are positioned near the opposing edges of the web-like body.

13. The spoke for a non-pneumatic wheel as in claim 1, wherein along the axial direction between the opposing edges the web-like body has a width that increases along the radial direction from the radially-inner end to the radially-outer end.

14. The spoke for a non-pneumatic wheel as in claim 1, wherein the outer anchor comprises a polymeric material having an elongation modulus MA10 measured at 10 percent elongation and at a temperature of 23° C. that is in the range of 10 to 30 MPa.

15. The spoke for a non-pneumatic wheel as in claim 1, wherein the inner anchor comprises a polymeric material having an elongation modulus MA10 measured at 10 percent elongation and at a temperature of 23° C. that is in the range of 20 to 60 MPa.

16. A non-pneumatic wheel comprising the spoke of any of the preceding claims.
